(19) United States
(12) Patent Application Publication
(10) Pub. No.: US 2024/0062920 A1
(43) Pub. Date: Feb. 22, 2024

(54) Resonant Pinch Thermonuclear Fusion Reactor

(71) Applicants: Daniel Prater, Muncie, IN (US); Mark William Chang, Palos Verdes Estates, CA (US)

(72) Inventors: Daniel Prater, Muncie, IN (US); Mark William Chang, Palos Verdes Estates, CA (US)

(21) Appl. No.: 18/453,714

(22) Filed: Aug. 22, 2023

Related U.S. Application Data
(60) Provisional application No. 63/399,812, filed on Aug. 22, 2022.

(51) Int. Cl. G21B 1/05; G21B 1/21

(52) U.S. Cl. CPC G21B 1/057; G21B 1/052; G21B 1/21

(57) ABSTRACT

A device and method for the generation of thermonuclear fusion through the resonant excitation of plasma. A resonant “bounce” effect is observed in shock-heated plasmas driven by a single current pulse with fast current rise-time. The present invention discloses means for resonant excitation of plasma at frequency derivatives of the bounce frequency including harmonics and subharmonics of the fundamental bounce frequency. The resonant excitation power circuit may employ a closed loop feedback circuit with an operational amplifier or be open loop employing a frequency reference and may include any configuration of inductors and capacitors. The reactor may be of any geometry and or configuration including linear pinch, theta pinch, toroidal pinch such as field-reversed configuration, magnetically stabilized pinches such as the tokamak, or may be steady state reactors.

### CROSS-REFERENCE TO RELATED APPLICATIONS

This non-provisional patent application claims the benefit of and/or priority under 35 U.S.C. § 119 to U.S. Provisional Patent Application Ser. No. 63/399,812 filed Aug. 22, 2022, titled “Resonant Pinch Thermonuclear Fusion Reactor”, the entire contents of which is specifically incorporated herein by this reference.

### FIELD OF THE INVENTION

The present invention relates in general to the subjects of ionized gas (plasma) devices, and specifically, to devices and methods for generating sufficient plasma temperatures and densities for sufficient time to produce economical and practical thermonuclear fusion-generated heat.

### BACKGROUND OF THE INVENTION

Devices for thermonuclear fusion have, prior to date, failed to generate a plasma with sufficient density and temperature for a sufficient period of time to be economically practical.

In practice, present-day thermonuclear fusion devices achieve a sufficient plasma temperature and density but fail to achieve sufficient plasma confinement time, or may achieve sufficient confinement time but fail to achieve sufficient temperature or density, etc.

The so-called “pinch” devices are among the first and are among the simplest machines to generate thermonuclear plasmas, and are well-known to those skilled in the art. They generate a magnetic field in plasma by passing a current through the plasma and can be linear or toroidal in geometry. The linear pinches are of the “z-pinch” and “theta-pinch” type and are well known to those skilled in the art. For example, the well-known Tokamak type of reactor is a toroidal field-stabilized theta-pinch reactor. In the z-pinch, a current is passed along the generally cylindrical device axis between two electrodes and the azimuthal magnetic field generated by the current compresses the plasma toward the axis. In the theta-pinch arrangement an axially aligned magnetic field is generated by passing an azimuthal current around the cylindrical plasma. In both cases the current, through induction, produces a magnetic field. The magnetic field constricts the plasma to an ever increasingly smaller diameter until the plasma disintegrates with of the many plasma instabilities well-known to those skilled in the art, such as the “kink” or “sausage”-type instabilities. Various means have been invented to stabilize the plasma column but, to date, no method has proved economical or practically effective.

The pinch reactors are variously linear or toroidal in geometry and may be “magnetically” stabilized as is well known to those skilled in the art. Among the toroidal geometries are the reversed-field pinch reactors. Tokamak-type reactors may be considered to be another type of toroidal pinch reactor, it producing a plasma that is stabilized by both toroidal and poloidal magnetic fields with ionization provided by a central solenoid. These embodiments of pinch reactors are well-known to those skilled in the art. Among the newest additions to magnetically stabilized reactors are those of Prater, U.S. Pat. No. 11,107,592, it using currents to provide for flowing plasma. In this case, the plasma is confined and stabilized by a combination of magnetic fields and plasma fluid flow.

The present invention is related to the above broad classes of reactors. The simplest analysis is for the dynamic pinch reactors. These were originally driven by a single current pulse from a power supply and would produce a single dynamic “spark” of plasma. In typical dynamic pinch thermonuclear fusion reactors, the external inductance of the power circuit supplying the energy to the pinch reactor is made adequately low (approx. 10\hat{ }-9 Henry or less), and the rise time of the current adequately fast (approx. 10\hat{ }13 Amperes/second or less) that the plasma is swept inward toward the plasma axis as a magnetohydrodynamic shock following the current pulse, for example, between the z-pinch electrodes or around the theta-pinch coil. In this way the ions acquire most of the energy of the discharge. A “snowplow” model has been developed by prior authors to describe the accumulation of energy and particle buildup. Dynamic pinch reactors and their operation are well-known to those skilled in the art.

Various means have been invented, such as the tokamak reactor configuration, to stabilize pinch reactors. Here, we depart from discussing stabilization and instead provide means to amplify the oscillatory compression behavior that is found to characterize shock-heated pinched plasmas to further heat the plasma beyond what is achievable from prior-art single-pulse pinch reactor operation.

At the 1958 Geneva Conference for the Peaceful Uses of Atomic Energy, the operation of various dynamic pinch reactors is described, as discussed by many authors including in “Nuclear Fusion”, edited by William P. Allis, part of the series “The Second Geneva Series on The Peaceful Uses of Atomic Energy”, series editor James G. Beckerley, by the D. Van Noistrand Company, Inc. Princeton, New Jersey, Toronto, New York, and London, 1960. Lev Artsimovich authored a lengthy discussion of dynamic pinch reactor operations in “Controlled Thermonuclear Reactions”, by Gordon & Breach Publishers (Edited by A. C. Kolb and R. S. Pease, English edition translated by P. Kelly and A. Peiperl, Oliver & Boyd Ltd and Gordon and Breach, Science Publishers, Inc. 1964) Chapter 5, Fast High Power Discharges, heretoafter referred to using square brackets and page numbers as [Art pXYZ]

In the proceeding references the oscillatory compression behavior is described following the initial current pulse that is sometimes called “bouncing” by authors such as S. R. Seshadri in Fundamentals of Plasma Physics, American Elsevier Publishing Company, 1973, p. 125-129, and J. A. Bittencourt who continued the sharing of Sashadri's description in his Fundamentals of Plasma Physics, by Pergamon Press, 1986, p. 250-355 and subsequent editions.

Seshadri writes, “[Following the current pulse] . . . . As the current sheet moves radially inwards, a wave motion is set up and this wave travels faster than the current sheet. These waves move radially inwards, get reflected off the axis, travel radially outwards and strike the current sheet whose motion is thus reversed. After a short interval of time, the magnetic forces predominate and the current sheet moves radially inwards again. This sequence of events takes place periodically with the result that the radius of the current sheet bounces about an equilibrium value . . . . The amplitude of each succeeding bounce becomes smaller and presumably the radius settles down to an equilibrium value. This phenomenon is known as bouncing.”

Artsimovich [Art] discusses the phenomenon of bouncing, noting the following, but providing little explanation for its origin and, similarly to Seshadri and Bittencourt, no suggestion of amplifying it.

Artsimovich writes, “On oscillograms of current and voltage, immediately after the breakdown of the spark-gap switch, both the current and the voltage vary smoothly. Then an inflection is observed in the current waveform. At the same instant, the voltage drops suddenly. Following this characteristic moment, the voltage and the current rise quickly. After a certain time interval, a second inflection point appears on the current oscillogram accompanied by a second abrupt voltage drop. In some cases, three consecutive inflections are observed on the current oscillogram with a corresponding drop in the voltage.” [Art p113]

“Thus the plasma undergoes rapid radial oscillations during the first quarter-period of the discharge. [Art p114]

“The time which the pinch diameter is minimum corresponds to the time of the current inflection. [Art p114]

“The converging process may be regarded just as the formation of a cylindrical shock wave converging at the axis. [Art p117]. The neutral gas is swept up by the charged particles mainly as a result of charge-exchange processes and is ionized. Thus, the mass which is set into motion increases and the number of ions and electrons in the imploding plasma shell rises rapidly. [Art p118] This is the “snowplow” model of particle accumulation.

“At the end of the first implosion, temperature and density increase rapidly. [Art p118]

“Under typical experimental conditions, the plasma temperature at the moment of maximum compression amounts to 1e6 to 3e6K (according to conservative estimates). [Art p120]

“Typical density at maximum compression is 10e17/cm-3 for initial gas pressure of 0.05 Torr and initial current rise of 10e11 A/sec. [Art p121]

Artsimovich notes, “The nature of the process taking place after the first maximum in the compression are not yet known. It is evident, however, that the maximum compression should be followed by an expanding shock wave moving outward towards the walls. The expanding wave should be decelerated by the electrodynamic forces, leading to a second compression phase, followed by a second expansion of the pinch.”

Artsimovich later discusses (see below) how neutrons are oftentimes produced at the second or third bounce indicating a positive benefit to thermonuclear heating.

Artsimovich further notes the difficulty in predicting and analyzing bouncing behavior. This may be one reason that the bouncing behavior has not been exploited for heating in known thermonuclear reactors. “Analysis of the pinch through a rough qualitative picture has been refined through two stages. Computation, of the macroscopic “snowplow” motion of an ionized gas acted upon by given electrodynamic forces taking into account the inertial forces, gives an estimate of the time to first compression but cannot be used beyond the time of the first compression. [Art p125]. In this analysis the plasma pressure is assumed to be zero during the entire compression.

Artsimovich continues, “In reality, the plasma pressure cannot be neglected since the capture of gas by the converging plasma shell is an inelastic process accompanied by heating. [Art p125] Adding a pressure term to the equation of motion (Art Eq 5.6 plus 2pi*a*p; see p125) allows extending the numerical analysis to radial oscillations following the first implosion. (see K. Hain, G. Hain, K. V. Roberts, S. J. Roberts and Köppendorfer. Fully ionized pinch collapse. Zeitschrift fur Naturforschung, vol. 15a, no. 12, pp. 1039-1050, December, 1960; here they could not extend the analysis past the first shock-wave reflection due to impurities buildup).

The summary result of the foregoing analysis is an inadequate description of the oscillatory (“bouncing”) behavior. An adequate description of “bouncing” behavior is not available for dynamically pinched plasmas, magnetically stabilized or not, nor has a predictive analysis for “bouncing” stable plasmas has been formulated, and no descriptions exist of the devices or power supplies to take advantage of bouncing behavior. It is an object of the present invention to cover as much of this lack as possible.

Neutron production seems to be dependant on bouncing behavior and bouncing permits a lower operating voltage. Artsimovich continues, “Neutrons, however, are often observed on the second or third compressions. If the initial electric field strength does not exceed 200-300V/cm neutrons are only observed at the second or third compression, never the first, at low initial gas pressure. If the value of the electric field is raised to 1500-2500V/cm, neutrons are also noted at the first compression. [Art p133]

The foregoing statement suggests that amplifying the bouncing behavior may be beneficial to heating the plasma, yet no suggestion of the sort is found after an exhaustive search of the literature.

Artsimovich continues, “Hard X-rays occur simultaneously with neutrons, also at the second and third maximum compression.

“Nevertheless, no definitive and widely accepted theory exists for the mechanism of hard X-ray and neutron radiation. At present, the analysis from 1960 appears to still hold. At very high values of the initial electric field, the acceleration produced by simple cylindrical compression may be sufficient to accelerate the ions to thermonuclear temperatures. [Art p140] Additional neutrons and hard X-rays are postulated to be due to high electric field acceleration processes occurring in the area of instabilities of, possibly, the “sausage” and “kink” types.

Hard X-rays indicate nuclear interactions among plasma particles and are suggestive of thermonuclear fusion reactions.

“At all values of the electric field a manifestation of the Fermi mechanism may apply. Here, after reaching the axis at the end of the first compression, the ion travels across it toward the converging inner wall of the magnetic channel formed by the pinch current and rebounds successively from the wall of the magnetic channel, and with each rebound its kinetic energy will increase. [Art p140]

“The foregoing descriptions were derived from linear pinch studies. Similar descriptions, though requiring special formulations depending on the geometry, may apply to triaxial pinches in which a central conducting rod carries a current opposite in direction to the plasma current, and to theta pinches. Triaxial pinches have received little experimental or theoretical attention as compared to linear pinches and theta pinches. [Art p144-146]

The foregoing suggests that pinch reactors of all types may show the oscillatory bouncing behavior when energized sufficiently rapidly.

Artsimovich further discusses the theta pinch geometry, “In the theta pinch, the figure of merit for the device is the maximum attainable magnetic field at maximum compression (100,000Oe-200,000Oe and above) in as short a time as possible (1-10 microseconds) using capacitor banks with energies about 2 megajoules for tubes surrounded by a single coil of about 2 m long (e.g., Pharos device, circa 1961). [Art p149]

“The results improve with a preliminary high-frequency discharge to pre-ionize the gas using a 30 kV capacitor bank of relatively small capacity. The magnetic field generated by the auxiliary circuit oscillates at a frequency several times larger than that of the main circuit. The plasma is, in effect, a capacitively-coupled discharge of temperature ˜1-5 eV, depending on density. Pharos used a staged pre-ionization and field-trapping scheme. If the field trapped was anti-parallel to the main field, then favorable results were produced. [Art p150]

“The main compression in Pharos was 0.7-1.5e7 cm/s depending on voltage, initial pressure, and coil radius. Then the plasma underwent a rapid expansion and subsequent oscillations followed by a relatively slow compression. These phases lasted for a time generally shorter than a quarter-period. There are indications of instability, plasma rotation, and breaking up into two separate filaments.

“Again, as in the linear discharge, neutrons are produced on the second or third half-cycles of the primary current. The neutrons and other radiation products do not contradict a thermal origin nor from an acceleration mechanism. [Art p153]

“Plate IX from Bodin [Art p145] shows theta-pinch bouncing.

“The snowplow model can account for bouncing in the theta-pinch model.

“There is no basis for a positive answer to the basic question of instability in a theta pinch. [Art p160].

Remarkably, given physical means for adding the energy to an oscillatory system through harmonic resonance, to date, no authors have suggested to oscillate plasma sympathetic to or in harmonic resonance with its fundamental bounce frequency.

Some typical linear dynamic pinch reactor parameters are (from Curran, et. al as reported by Allis):

Working voltage 10-30 kV.

Maximum discharge current from 10-20 kiloamperes to >2 millionamperes.

Initial rate of current rise from 10e10 to 10e12 amperes/second.

If capacitors are used, they have been charged 3-120 kilovolts.

Stored energy ˜10e6 Joules.

Parasitic inductance of circuit ˜0.01-0.02 microhenry.

Gas pressure of ˜0.1 torr is ideal [Arz pgs133 & 153 notes experiments ranged from 5e-3-hundreds torr].

Some additional typical parameters (from Andrianov, et. al as reported by Allis):

20-120V condenser voltage.

Maximum current 200-1600 kA.

Current rise (di/dt) maximum of 10e11-10e12 A/sec.

Energy stored in capacitor bank 5e5 joules.

Resonant pinch fusion reactors may be axial, for instance, as alternating current forms of the Columbus I and II experiments or of the linear theta(θ)-pinch type, or triaxial, or toroidal as in the reversed-field pinch type, or any other arrangement including magnetic or non-magnetic as is well known by those skilled in the art.

There are some benefits to the linear θ-pinch type over z-pinches:

“The compression of the plasma in strong external fields represents a more effective method of obtaining high temperatures than the linear pinch [Art p160].

“Yield in reactors of the theta-pinch type is independent of current rise-time or duration of the heating cycle.” [Art p109]

The above may indicate further improving resonant pinch reactor operation through theta-pinch means in a toroidal geometry as in the reversed-field pinch type and particularly with a magnetically confined stable plasma. Theta-pinch plasmas are well-known to be more stable than z-pinch plasmas.

The stable plasma may prove advantageous to heating as it exists in a minimum “potential energy well” as defines it stability to harmonic perturbation. In the first quarter-cycle during compression heating. the primary time period in the foregoing analysis by Artsimovich, the dynamic pinch plasma is not, at that time, disrupting into an instability but in laminar flow as in the stable magnetically confined plasma of, for example, Prater U.S. Pat. No. 11,107,592.

Lastly, it is noteworthy that Winston Bostick, in his article “The Pinch Effect Revisited”, the inaugural article of the International Journal of Fusion Energy, vol. 1, no. 1, March 1977, does not mention the oscillatory behavior of pinched plasmas.

### SUMMARY OF THE INVENTION

The resonant pinch thermonuclear reactor embodies modifications of the various dynamic pinch reactors, through power by a current source alternating at some integer multiple or integer fraction of the plasma oscillatory “bounce” frequency. This frequency may be dynamically adjusted during reactor operation. The plasma may be magnetized for stability or confinement as in the tokamak or the device of Prater U.S. Pat. No. 11,107,592. Additional improvements include using a high rate of current rise, for example using an alternating current with an approximately square waveform, and the movement of the quartz, Mullite (alumina), or other discharge chamber wall far enough radially from the device axis that arcing between electrodes and wall does not occur and impurity production is limited. Removal of the non-conductive wall allows for fuel recycling and ash removal. The primary benefit of this reactor for the production of fusion power is its relatively low cost.

The resonant pinch thermonuclear reactor, whether for fusion or other nuclear transmutations, is an extension of the “ordinary” dynamic pinch reactor. The dynamic pinch reactor, when subjected to a high rate of current rise such that the “snowplow” model of particle accumulation at a shock front is relevant, displays the phenomenon of “bouncing”. As the current sheet moves radially inwards, a wave is formed that moves radially inwards ahead of the current sheet and is reflected at the axis, traveling then radially outwards striking the current sheet whose motion is thus reversed. In a short interval of time the magnetic forces again dominate and the current sheet moves radially inwards again. This sequence takes place periodically with the result that the radius of the current sheet bounces about an equilibrium position. The amplitude of each succeeding bounce becomes smaller in the ordinary dynamic pinch. The period of a bounce is about a microsecond for an electrode of ˜10 cm and thus the bounce frequency is about 1 MHz. This is well within the range of radio electronics power. In the resonant pinch the bounce effect is maintained or amplified by subsequent discharges from the alternating current source. These subsequent maintenance or amplification powering discharges may be dynamically changed in time by increasing or decreasing the powering rate or changing from one harmonic to another, for example by powering at the fundamental bounce frequency to powering at a sub-harmonic. Other dynamic modifications such as from a sub-harmonic to the fundamental serve as additional embodiments.

Typical experiments to date, mostly conducted in the period 1951-1958, focused on the first ¼-period during which the plasma current builds up to a maximum. The rest was ignored because of contamination from the adjacent wall material by the end of the first half-period [Art p113]. The duration of the first ¼-cycle is from ˜1-10 microseconds. Contamination from walls is the primary motivation to move the container walls far from the plasma. This may prove relevant to linear z-pinch configurations. In theta pinch reactors an energizing coil surrounds the plasma.

This invention improves upon the conventional pinch fusion reactor by exciting the plasma with an alternating or fast repeating pulse current at a frequency that is in sympathetic or harmonic resonance with the natural periodic frequency of the plasma energy and electrical reactances. Such a resonant system can result in the sequential, regenerative buildup of plasma energy and heating, reaching amplitudes exceeding that produced by single isolated pulses.

Artsimovich and Allis describe researches on pinch reactors excited by capacitor discharge via spark gaps producing single fast rise time pulses. The resulting plasma energy recorded over a time interval following each discharge pulse displayed resonant oscillatory behavior with a period of approximately 750 nanoseconds, proportional to the dimensions of the plasma enclosure and reactances in the electrical components including spark gaps and transmission line. This observed resonance can be exploited to produce higher plasma energy levels than that achieved through conventional single pulse methods.

Generation and heating of plasma are by any means known to those with skill in the art, including microwave heating, ion cyclotron resonance generation and heating, capacitive-coupled generation and heating, neutral beam injection, shock injection and heating, and etc.

Those of skill in the art will understand that various details of the invention may be changed without departing from the spirit and scope of the invention. Furthermore, the foregoing description is for illustration only, and not for the purpose of limitation, the invention being defined by the claims.

### DESCRIPTION OF THE DRAWINGS

The mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a prior art schematic diagram of an ordinary dynamic pinch reactor excited by a single pulse of power 14 having a fast rise-time approximated by a square pulse;

FIG. 2 is a graph of the plasma rate of change of current (di/dt, solid line, and left abscissa indices) showing a typical oscillatory (bouncing) waveform response following a single current pulse (Pulse Current, solid line, and right abscissa indices) with a “fast” rise-time in a typical dynamic z-pinch reactor;

FIG. 3 is an overall schematic diagram of an embodiment of harmonic resonance excitation of a pinch reactor that uses electrical feedback circuitry and amplification by an operational amplifier to build up and sustain oscillatory excitation at the fundamental resonant frequency or a multiple or sub-harmonic of the fundamental frequency of the plasma bouncing;

FIG. 4 is an overall schematic diagram of an embodiment of the invention using an external frequency reference to produce a pulsed, sinusoidal, or other periodic current waveform to excite the reactor at or near the resonant bounce frequency;

FIG. 5a is an overall schematic diagram showing an input external frequency reference to produce a pulsed, sinusoidal, or other periodic waveform into a series inductance-capacitance circuit in the power system powering the pinch reactor;

FIG. 5b is an overall schematic diagram showing an input external frequency reference to produce a pulsed, sinusoidal, or other periodic waveform into a tank circuit having a capacitor and inductor in parallel in the power system powering pinch reactor;

FIG. 5c is an overall schematic diagram showing an input external frequency reference to produce a pulsed, sinusoidal, or other periodic waveform into a transformer in the power system powering pinch reactor;

FIG. 5d is an overall schematic diagram showing an input external frequency reference to produce a pulsed, sinusoidal, or other periodic waveform into a tank circuit with an inductor and capacitors in the power system powering pinch reactor; and

FIG. 6 is an overall schematic diagram showing a further embodiment of the inventions described using a subharmonic of the fundamental resonant bounce frequency for excitation at Fs=(1/n)*F0, (where n is an integer value and F0 is the fundamental frequency).

For the purpose of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the described embodiments, and any further applications of the principles of the invention as described herein are contemplated as would normally occur to one skilled in the art to which the invention relates.

### DETAILED DESCRIPTION OF THE INVENTION

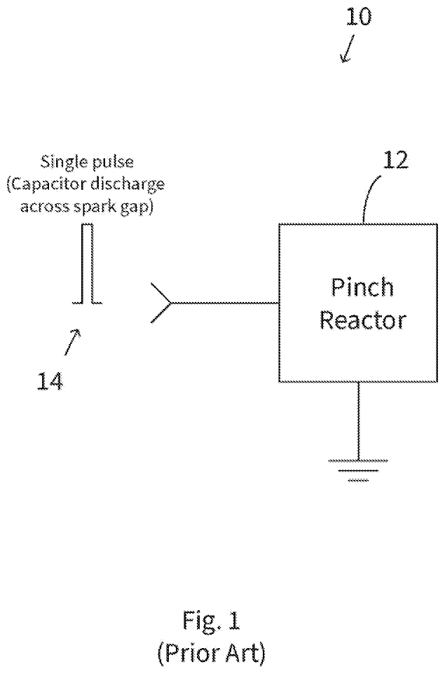

FIG. 1 shows a prior art overall schematic diagram 10 of an ordinary dynamic pinch reactor 12 excited by a single pulse of power 14 having a fast rise-time approximated by a square pulse. The pinch reactor 12 could be of the linear-pinch type or theta-pinch type or any other design (e.g., triaxial), or magnetically stabilized such as a tokamak. The geometry, construction, and configuration of pinch reactors are well known to those skilled in the art and we do not show these unnecessary details. The details of pinch reactor operation are well known to those skilled in the art.

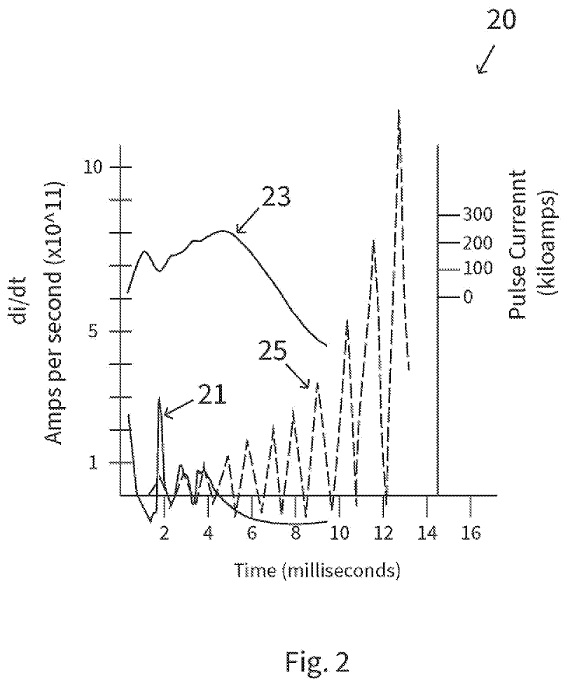

FIG. 2 is a graph 20 of the plasma rate of change of current 21 (di/dt, solid line, and left abscissa indices) showing a typical oscillatory (bouncing) waveform response following a single current pulse 23 (Pulse Current, solid line, and right abscissa indices) with a “fast” rise-time in a typical dynamic z-pinch reactor. Overlaid on top of this is a dashed waveform showing a hypothetical rate of change of current 25 following resonant excitation of the present invention. The present invention improves upon the conventional pinch fusion reactor by exciting the plasma with an alternating or fast repeating pulse current (not shown for clarity as they may overlap the response rate of change of current) at a frequency that is in sympathetic or harmonic resonance with the natural periodic frequency of the plasma energy and electrical reactances. Such a resonant system can result in the sequential regenerative buildup of plasma energy and heating, as shown by the approximately exponential increase in rate of change of current 25 reaching amplitudes exceeding that produced by single isolated pulses.

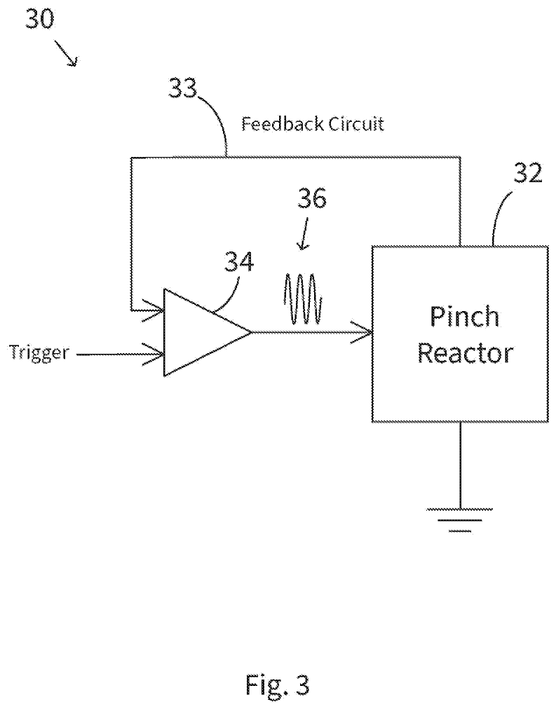

In FIG. 3 there is shown an overall schematic diagram 30 of an embodiment of harmonic resonance excitation of a pinch reactor 32 that uses electrical feedback circuit 33 and amplification by an operational amplifier 34 to build up and sustain oscillatory excitation 36 at the fundamental resonant frequency or a multiple or sub-harmonic of the fundamental frequency of the plasma bouncing. This may be termed the “closed loop” embodiment. A feedback circuit allows to automatically adjust frequency according to changes in the bounce frequency in response to changes in the plasma, for example, as the plasma is heated, etc. In this embodiment an external trigger is applied to the operational amplifier 34 at a specified frequency to excite the resonant system. The trigger may be dynamically repeated in time in response to measurements of plasma performance characteristics. Circuit design for feedback and amplification of oscillatory behavior is well-known to those skilled in the art of feedback amplification, however, to date, these circuit designs have not been applied to pinch-type thermonuclear fusion reactors 32.

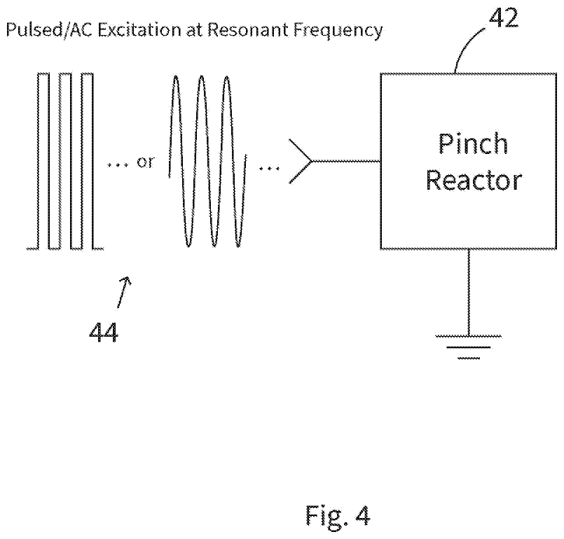

In FIG. 4 there is shown an overall schematic diagram 40 of an embodiment of the invention that uses an external frequency reference to produce a pulsed, sinusoidal, or other periodic current waveform 44 to excite the reactor 42 at or near the resonant bounce frequency. This embodiment may be termed the “open loop” embodiment. A fast rise-time could, for example, be produced with an approximately square waveform.

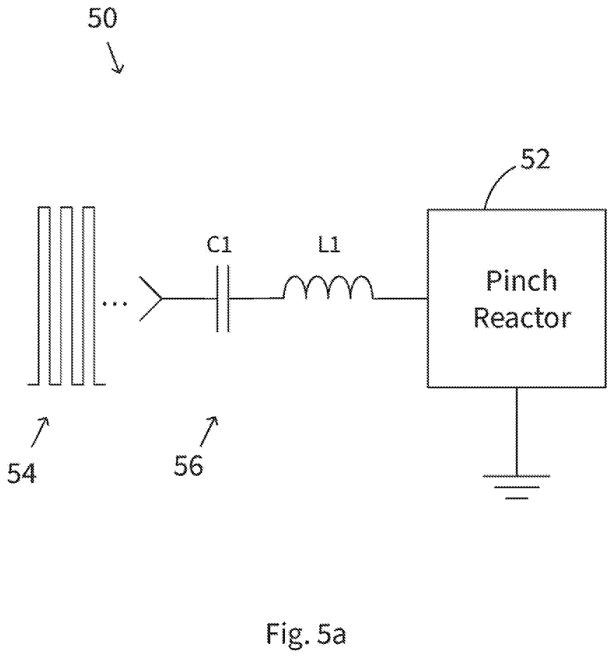

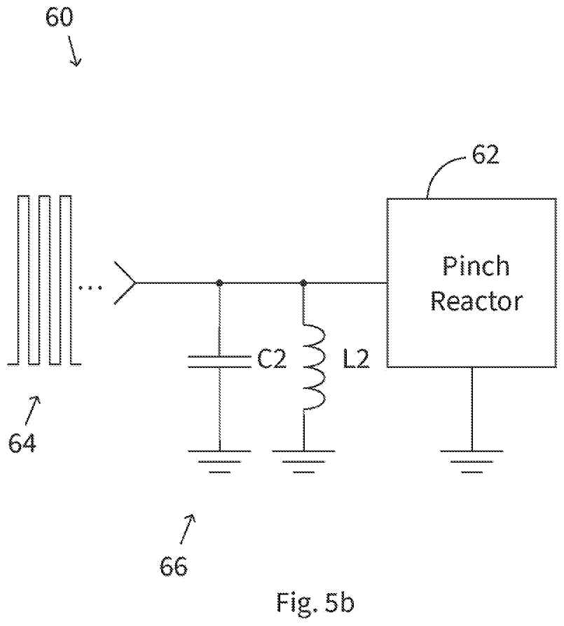

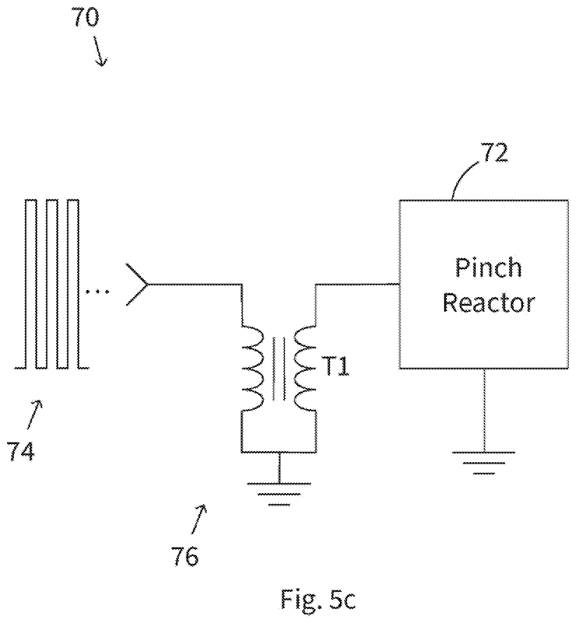

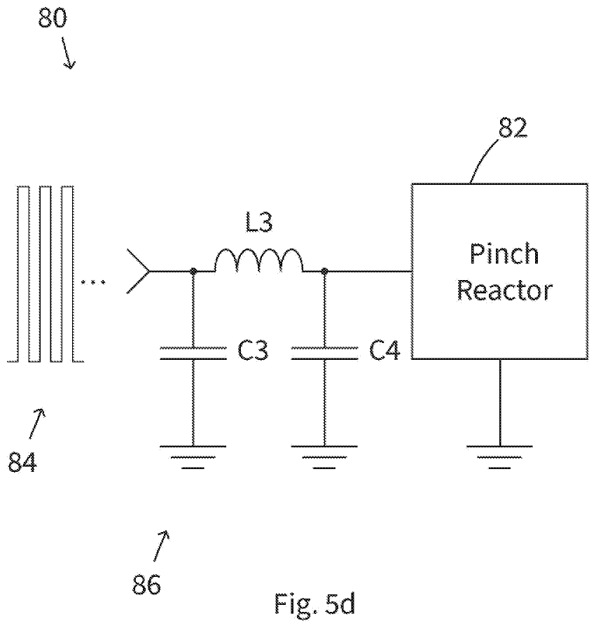

In FIGS. 5a-5d further example embodiments of the invention described above adds electrical reactances and/or impedance matching networks and/or transformers in the excitation circuit to enhance the resonant Q (quality factor) and efficiency of the combined circuit and plasma. These circuits may be employed in “open-loop” configurations of FIG. 4 between the Pulsed/AC excitation at the resonant frequency or at the location 36 of FIG. 3 in the “closed-loop” embodiment. The resonant circuit may be a simple series or parallel LC circuit (FIGS. 5a and 5b), or a circuit formed by an inductor and two capacitors (parallel LCC, FIG. 5d), or two inductors and one capacitor (parallel LLC, FIG. 5c), or a parallel LLCC circuit (not shown) or any other combination of inductors and capacitors. FIGS. 5a-5c are shown as multiple embodiments to serve as example resonant circuits.

In FIG. 5a there is shown an overall schematic diagram 50 showing an input external frequency reference to produce a pulsed, sinusoidal, or other periodic waveform 54 into a series inductance-capacitance circuit 56 having capacitor C1 and inductor L1 in the power system powering pinch reactor 52.

In FIG. 5b there is shown an overall schematic diagram 60 showing an input external frequency reference to produce a pulsed, sinusoidal, or other periodic waveform 64 into a tank circuit 66 having capacitor C2 and inductor L2 in parallel in the power system powering pinch reactor 62.

In FIG. 5c there is shown an overall schematic diagram 70 showing an input external frequency reference to produce a pulsed, sinusoidal, or other periodic waveform 74 into a transformer 76 in the power system powering pinch reactor 72.

In FIG. 5d there is shown an overall schematic diagram 80 showing an input external frequency reference to produce a pulsed, sinusoidal, or other periodic waveform 84 into a tank circuit 86 with inductor L3 and capacitors C3 and C4 in the power system powering pinch reactor 82.

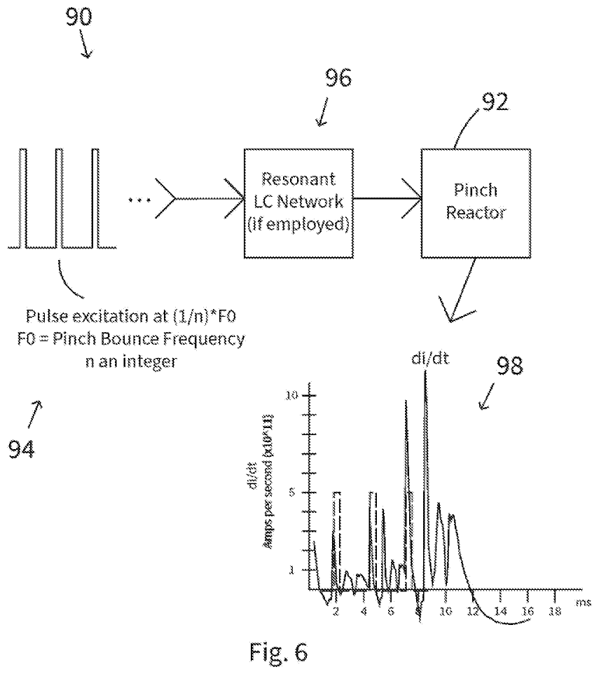

FIG. 6 shows an overall schematic diagram 90 showing a further example embodiment of the inventions described above uses a subharmonic of the fundamental resonant bounce frequency for excitation at Fs=(1/n)*F0, (where n is an integer value and F0 is the fundamental frequency) 94. Here, the subharmonic frequency is used for excitation rather than the fundamental frequency. Subharmonic excitation enables the use of slower switching devices and larger capacitor banks while still producing the desired regenerative amplification effect and may be employed with or without a resonant LC circuit 96 in the power system powering pinch reactor 92. An idealized input is shown, and hypothetical output is shown in graph 98. Here the input power (dashed line) is shown as a square wave with an input of approximately ⅓^{rd} of the bounce frequency resulting in a hypothetical approximately exponential growth in plasma current response (solid curve).

A further embodiment of the invention described above adds the dimensions of the plasma chamber, spark gaps, and other electrical components adjusted to optimize the resonant frequency, resonant Q, waveform, rise time, and efficiency of the system such that the resulting plasma energy amplitude and containment properties are optimized. This may include matching impedances and matching capacitive and inductive reactances in the system.

A further embodiment of the invention described above adds spark gap(s) to improve rise time or otherwise modify the excitation waveform such that the resulting plasma energy amplitude and containment properties are optimized.

A further embodiment of the invention described above adds employing mechanically or electronically switched spark gap(s), such as but not limited to rotary spark gaps, to produce the high frequency pulses required for resonant excitation of the plasma.

A further embodiment of the invention described in any of the foregoing embodiments adds pre-ionization techniques, such as microwave heating of the electrons, to enhance the quality and amplitude of the plasma.

The pinch reactor walls may be moved to a distance far from the device axis to limit impurity generation during discharge to an acceptable level. This level will be the level whereupon parasitic impurity cooling results in acceptable reactor performance and will be determined at the engineering design phase in power balance calculations. The construction of pinch reactors within vacuum chambers is well known to those skilled in the art and need not be shown.

Interior to the reactor is a vacuum vessel (not shown). Within the vacuum vessel is plasma and, in the case for a linear pinch, electrodes. This vacuum vessel can be made of steel, ceramic, quartz, or any of the materials commonly used for plasma confinement vessels and may or may not be coated by titanium or other materials as is well known to those skilled in the art. In transverse section at the equatorial plane the vacuum region may be generally cylindrical, annular, toroidal, or circular, or any other geometry. In transverse section, the vacuum vessel may be closed to particle loss, whereon charged particles will impinge on the vacuum vessel wall, or open, and in the open case continuous into, in one embodiment, a region of electrostatic deceleration electrodes known to those with skill in the art as “direct fusion energy conversion.” For simplicity, preferably the vacuum vessel wall is composed of a ceramic or quartz or other suitable material whereas in commercial practice preferably the vacuum vessel will be continuous into a region of electrostatic deceleration electrodes.

Plasma is created and heated by any means and preferentially heated transverse to the magnetic field. For instance, this can be accomplished by inductively coupled plasma induction coils operating at radio- or microwave frequencies. Other means of plasma generation and heating, including capacitive coupling, shockwave plasma generation and heating, and neutral beam injection, etc., are known to those with skill in the art. No heating scheme is specifically excluded from preferred embodiments of the present invention.

Although the drawing represents an embodiment of various features and components according to the present invention, the drawing is not necessarily to scale, and certain features may be enhanced in order to better illustrate and explain the present invention. The exemplifications set out herein thus illustrate embodiments of the invention, and such exemplifications are not to be construed as limiting the scope of the invention in any manner.

While the invention has been illustrated and described in detail in the foregoing drawing and description, the same is to be considered as illustrative and not restrictive in character, it being understood that only an illustrative embodiment thereof have been shown and described and that all changes and modifications that are within the scope of the following claims are desired to be protected.

It should be appreciated that not all of the features of the components of the figures are necessarily described. Some of these non-discussed features as well as discussed features are inherent from the figures. Other non-discussed features may be inherent in component geometry and/or configuration.

What is claimed is:

1. A device for thermonuclear heating of plasma comprising:
a pinch reactor; and
an oscillatory electric current power source in communication with the pinch reactor and configured to energize the pinch reactor.

2. The device of claim 1, wherein the pinch reactor is linear in geometry.

3. The device of claim 2, wherein the pinch reactor comprises a linear z-pinch reactor.

4. The device of claim 2, wherein the pinch reactor comprises a linear theta-pinch reactor.

5. The device of claim 1, wherein the pinch reactor is toroidal in geometry.

6. The device of claim 5, wherein the pinch reactor comprises a toroidal reversed-field pinch reactor.

7. The device of claim 1, wherein the pinch reactor comprises a triaxial pinch reactor.

8. The device of claim 1, wherein the pinch reactor comprises one of magnetic fluid flow stabilization, plasma fluid flow stabilization, magnetic fluid flow confinement, and plasma fluid flow confinement.

9. The device of claim 8, wherein the pinch reactor includes a stable plasma within the reactor.

10. The device of claim 1, wherein the oscillatory electric current power source has a fundamental frequency of a plasma bounce effect.

11. The device of claim 10, wherein the oscillatory electric current power source is dynamically adjusted to enhance the plasma bounce effect.

12. The device of claim 10, wherein the oscillatory electric current power source is a harmonic or subharmonic of the fundamental frequency of the plasma bounce effect.

13. The device of claim 10, wherein the oscillatory electric current power source includes a closed loop circuit for oscillating electric current that uses electrical feedback and amplification to respond to changes in plasma bounce frequency and to build up and sustain oscillatory bouncing.

14. The device of claim 10, wherein the oscillatory electric current power source includes an open loop circuit that uses an external frequency reference to produce pulsed, sinusoidal, or other periodic current waveform.

15. The device of claim 10, wherein the oscillatory electric current power source includes one of electrical reactances, impedance matching networks, or transformers in an excitation circuit to enhance the resonant Q and efficiency of the plasma reaction.

16. The device of claim 10, wherein a plasma chamber of the pinch reactor, electrodes, coil or coils, spark gaps, and other electrical components of the oscillatory electric current power source are adjusted to optimize resonant frequency, resonant Q, waveform, rise time, and efficiency of the system such that the resulting plasma energy amplitude and containment properties are optimized.

17. The device of claim 10, wherein the oscillator electric current power source includes one or more mechanically or electronically switched spark gaps to produce the high frequency pulses.

18. The device of claim 10, having pre-ionization techniques to enhance the quality of the plasma.

19. A method for thermonuclear heating of plasma comprising:
providing a pinch reactor;
providing an oscillatory electric current power source in communication with the pinch reactor; and
energizing the pinch reactor with an oscillatory electric current from the oscillatory electric current power source to generate thermonuclear fusion through the resonant excitation of plasma.

20. The method of claim 19, wherein the oscillatory electric current power source provides a fundamental frequency of a plasma bounce effect, the oscillatory electric current power source is dynamically adjusted to enhance the plasma bounce effect, and the oscillatory electric current power source is a harmonic or subharmonic of the fundamental frequency of the plasma bounce effect.
